(19) United States
(12) Patent Application Publication
(10) Pub. No.: US 2007/0070379 A1
(43) Pub. Date: Mar. 29, 2007

(54) Planning print production

(76) Inventors: Sudhendu Rai, Fairport, NY (US); Michael E. Farrell, Williamson, NY (US); Javier A. Morales, Rochester, NY (US)

Correspondence Address: Clifford P. Kelly;Alix, Yale & Ristas, LLP, 750 Main Street, Hartford, CT, 06103-2721, US

(21) Appl. No.: 11/238,892

(22) Filed: Sep. 29, 2005

(51) Int. Cl. G06F 3/12

(52) U.S. Cl. 358/1.13; 358/1.15

(57) ABSTRACT

A method of planning print production in a print production enterprise, having multiple print shop equipment components performing multiple discrete printing operations, includes gathering print job data and populating the variables of a simulation algorithm with the print job data. The print job production run is planned utilizing the simulation algorithm and then implemented. Multiple workflow variables associated with the print job production run are measured and the variables of the simulation algorithm are conformed to the measured workflow variables.

### BACKGROUND

This disclosure relates generally to print production enterprise process workflow. More particularly, the present disclosure relates to print production planning.

Conventional print shops are organized in a fashion that is functionally independent of print job complexity, print job mix, and total volume of print jobs. Typically, related equipment is grouped together. Thus, all printing equipment is grouped and located in a single locale. Similarly, all finishing equipment is grouped and located in a single locale. In other words, conventional print shops organize resources into separate departments, where each department corresponds to a type of process or operation that is performed to complete a print job. When a print job arrives from a customer, the print job sequentially passes through each department. Once the print job is completely processed by a first department, the print job gets queued for the next department. This approach continues until the print job is completed.

Accurate job production predictions for production planning are usually a challenge for most print shops. In general, print shops have overall windows of time that they allow for job production operations (e.g. 3 days for prepress, 24 hours for UV coating, 5 days for outsourced binding, etc.). These allocations of time are generally based on the average time that each such operation has taken to perform in the past. The time allocations also assume that certain print shop equipment is available for performing the tasks and that a certain level of work is being performed in the shop. Accordingly, actual production times for specific jobs may vary from these allotted times depending on current workload, equipment availability/reliability, etc.

Print shop managers are able to determine how far a job has progressed through the production process. However, when it comes to determining whether the job is on track to be produced within the allowed window of time, the shop managers rely largely on ensuring that past production on the document has not exceeded the allowed windows of time (e.g. prepress took 3 days or less). While this is satisfactory for ensuring that print jobs are moving through the shop at the desired rate, this does not give any indication of the likelihood that the overall job will be produced within the desired time frame. Furthermore, since the times estimated for each operation are fixed, the print shop will generally underestimate capacity by setting very conservative windows of time each operation.

### SUMMARY

There is provided a method of planning print production in a print production enterprise having multiple print equipment components performing multiple discrete printing operations. The method comprises gathering print job data and populating the variables of a simulation algorithm with the print job data. The print job production run is planned utilizing the simulation algorithm and then implemented. Multiple workflow variables associated with the print job production run are measured and the variables of the simulation algorithm are conformed to the measured workflow variables.

In a method of planning print production in a print production enterprise, a neural network having a multiple neurons is created. Each of the neurons is connected to at least one other neuron by a logic connection. The neural network is trained and a print job is planned utilizing the trained neural network.

The print job planned by the trained neural network is implemented. At least one workflow variable associated with the print job is measured and the neural network is retrained utilizing the measured variables.

Creating the neural network comprises inventorying the print equipment components and modeling a workflow of the print production enterprise. The print equipment components are mapped and a position for each print equipment component relative to each other print equipment component is determined.

The neural network is updated when a new equipment component is added to the print production enterprise or one of the print equipment components is permanently removed from the print production enterprise. The neural network is also updated when one of the print equipment components is unavailable due to maintenance or repair or one of the print equipment components is unavailable due to a prior commitment to another print job.

Training the neural network comprises measuring multiple workflow variables associated with the print equipment components and assigning a weighting factor to each logic connection.

In a method of method of planning print production in a print production enterprise having multiple print equipment components performing multiple discrete printing operations print job data is gathered. Variables of Monte Carlo simulation algorithm are populated with the print job data. The print job production run time is calculated utilizing the Monte Carlo simulation algorithm and the print job production run is implemented. Multiple workflow variables associated with the print job production run are measured. The variables of the Monte Carlo simulation algorithm are then conformed to the measured workflow variables.

Calculating the print job production run time comprises defining the specific operations that need to be simulated to simulate the print job. A proper quantity range for each of the defined operations is determined. A current set of range values and a statistical distribution profile for the specific quantity range for each operation are inputted into the Monte Carlo simulation. The estimated run times for all of the discrete operation operations are aggregated into an estimated run time for the print job. The Monte Carlo simulation is then initiated.

Other print jobs in production in the print production enterprise may be identified. A quantity of work each defined operation has scheduled for the other print jobs is then determined and data from the Monte Carlo simulations for the other print jobs is evaluated. A time of active operation for each print equipment component required to perform the identified operations of the other print jobs is determined and the required times for each operation for each print equipment component for the other print jobs is aggregated.

Determining a proper quantity range for each of the defined operations includes dividing at least one of the discreet operations into multiple quantity ranges. The proper quantity range for each of the defined operations is determined based on job meta data. The statistical distribution profile for the specific quantity range is determined based on actual shop data.

### BRIEF DESCRIPTION OF THE DRAWINGS

The present disclosure may be better understood and its numerous objects and advantages will become apparent to those skilled in the art by reference to the accompanying drawings in which:

FIG. 1 is a schematic view of a neural network model;

FIG. 2 is a layout of an example print production enterprise showing various print equipment;

FIG. 3 is a table of job and timing data collected from the example print production enterprise;

FIG. 4 is flow diagram of a first embodiment of a method for planning print production in accordance with the present disclosure;

FIG. 5 is flow diagram of creating and training a neural network;

FIG. 6 is flow diagram of a second embodiment of a method for planning print production in accordance with the present disclosure; and

FIG. 7 is a flow diagram of calculating production time for a print job.

### DETAILED DESCRIPTION

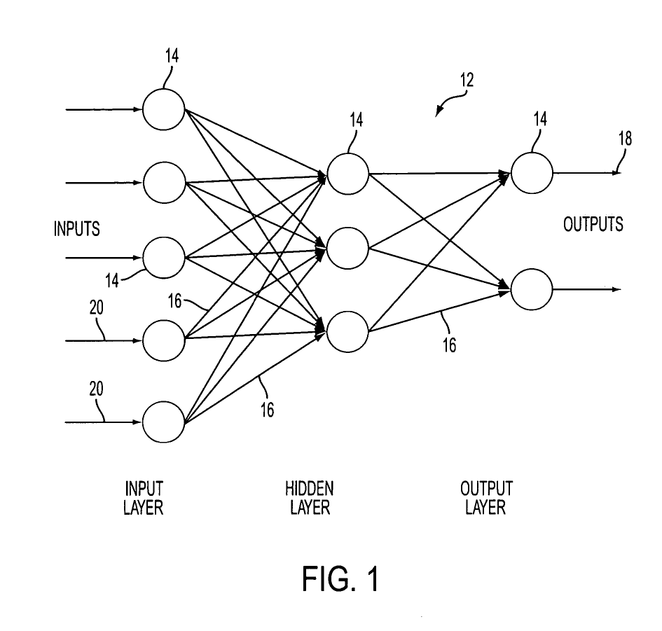

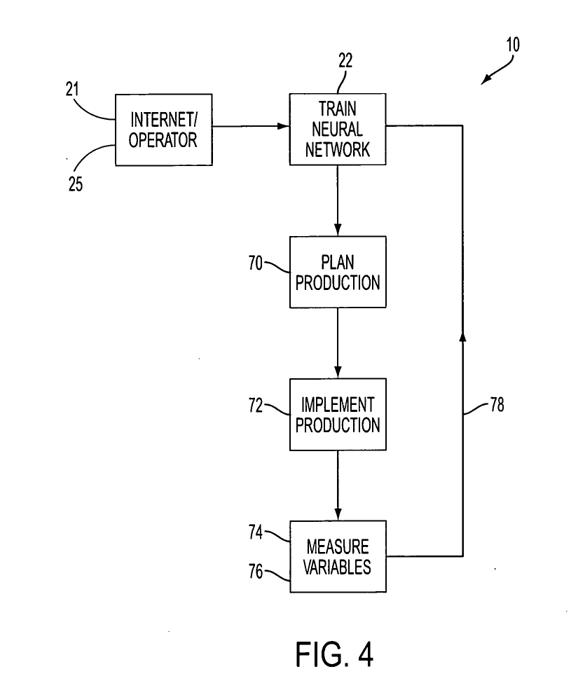

With reference to the drawings wherein like numerals represent like parts throughout the several figures, a first embodiment of a method for planning print production 10 in accordance with the present disclosure utilizes a neural network 12 (FIG. 1) that learns to accurately predict turnaround time is shown in FIG. 4.

Neural networks 12 have been used to approximate input-output mappings when the structure of the mapping is difficult to extract from first principles modeling. A neural network 12 is an information processing paradigm that is inspired by the way biological nervous systems, such as the brain, process information. The key element of this paradigm is the novel structure of the information processing system. It is composed of a large number of highly interconnected processing elements (neurons) 14 working in unison to solve specific problems. A basic representation of a neural network 12 is shown in FIG. 1. Neural networks 12, with their remarkable ability to derive meaning from complicated or imprecise data, can be used to extract patterns and detect trends that are too complex to be noticed by either humans or other computer techniques. A trained neural network 12 can be thought of as an “expert” in the category of information it has been given to analyze. This expert can then be used to provide projections given new situations of interest and answer “what if” questions.

To create 21 the neural network 12, an input/output model of a print production enterprise must be developed. In other words, the print equipment 26 must be inventoried 24 and the print production enterprise workflow must be modeled 23. The basic premise of the learning model for predicting turnaround time performance disclosed herein is that the model attempts to capture all constraints of operations. It should be appreciated that although a given print job may require that certain printing operations be performed, these operations are not necessarily constrained to a specific sequence of performance. Accordingly, the mapping should accommodate each variation of workflow that may be performed by the print equipment components installed in the print production enterprise. Therefore, the term “modeling” includes defining each and every workflow connection between each print equipment component and each other print equipment component. The model includes provisions for remote learning 25, whereby the neural network 12 may be maintained at a location remote from the print production enterprise. Accordingly, the model is a better and faster predictor of turnaround time than conventional means for predicting print job turnaround time.

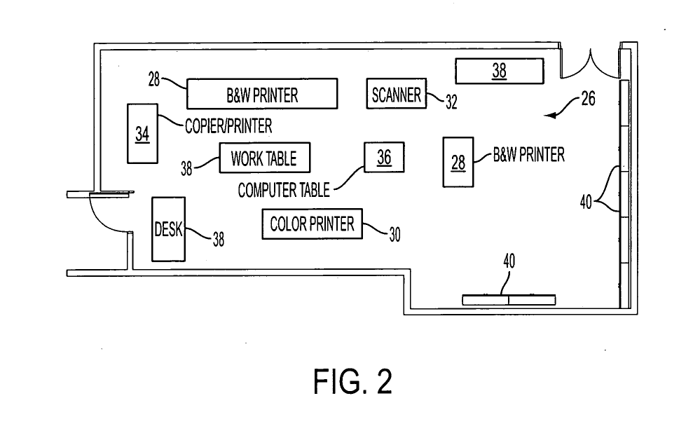

As shown in FIG. 2, the equipment 26 found in a print production enterprise may include one or more black and white printers 28, a color printer 30, a scanner 32, a copier 34 (which may also function as a printer), a computer 36, various work surfaces 38, and supply cabinets or shelving 40. It should be appreciated that job planning cannot be properly performed unless all of the installed, and available, equipment 26 is considered. Accordingly, the input/output model of a print production enterprise must at least include an inventory of the equipment 26 found in the print production enterprise. In addition, the input/output model should include information on the location of each piece of equipment 26, to most efficiently plan the movement of print jobs within the shop. Accordingly, the print equipment is mapped 42 to determine the relative locations of each piece of equipment 26. The term “mapping” includes defining the physical location of each print equipment component, on an absolute bases (e.g. latitude and longitude), a relative basis with respect to each other print equipment component, or both. It should be appreciated that the input/output model should include provisions for revising the inventory of shop equipment 26, to account for the addition of new equipment, the disposal of old equipment, and changes in the shop layout. In addition, the input/output model should account for equipment that is temporarily unavailable due to maintenance or a prior commitment to another print job.

Neural networks 12, like people, learn by example. A neural network 12 is configured for a specific application, such as pattern recognition or data classification, through a learning process. Learning in biological systems involves adjustments to the synaptic connections that exist between the neurons. This is true of neural networks 12 as well. Once the network 12 has been trained, it can be used to predict the output 18 for any given input 20. The advantage of this training method is that it can learn quite arbitrary mappings with significant non-linearity that may be very difficult to model using first-principles modeling.

Teaching the neural network 12 initially includes assigning a weighting factor to each of the logic connections 16. Accordingly, the term “training the neural network” shall include assigning weighting factors to the logic connections 16 of a new neural network 12, as described above. For existing neural networks 12, “training the neural network” shall include updating the weighting factors of the logic connections 16 based on feedback from completed print jobs, as described below.

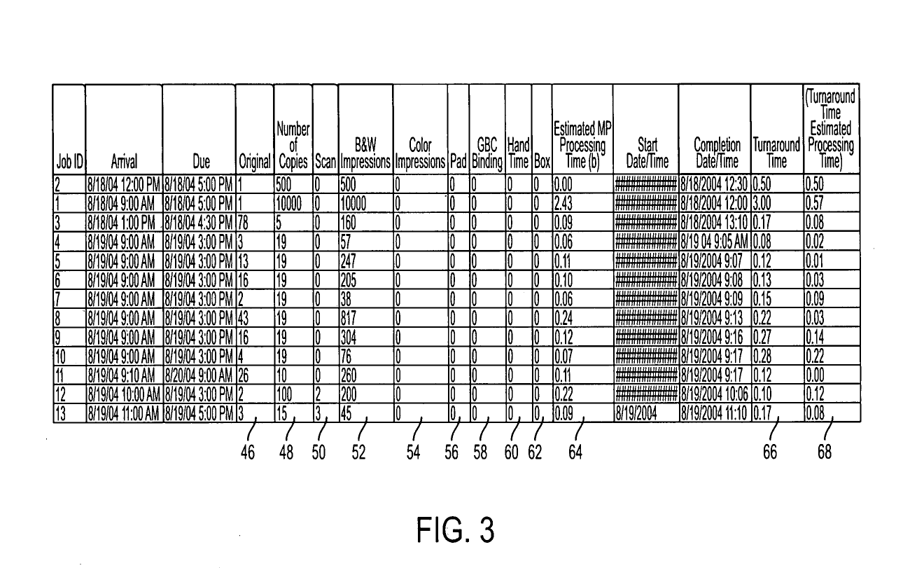

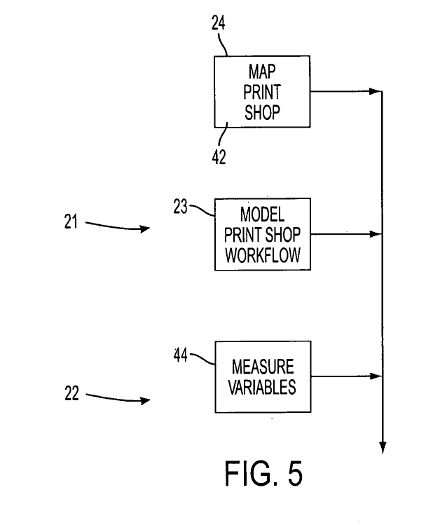

With reference to FIG. 5, training 22 the neural network 12 requires measurement 44 of all the variables that affect the desired outcome and use these measurements to train the network 12. If the input/output model is to be used for planning work in an existing shop, information on print jobs performed within the print production enterprise may be used to teach the neural network 12. FIG. 3 is a table of such information collected from the exemplary shop for 776 jobs over a period of over 3 months. The data selected for input to the input/output model included: number of originals 46; number of copies 48; scan quantity 50; black and white (BW) impressions 52; color impressions 54; padding quantity 56; coil bound books 58; handtime quantity 60; number of boxes to pack 62; and the actual turnaround time 66 (measured in the hours that the shop is open). An estimated processing time 64 was calculated from the production rate estimates and compared to the actual turnaround time 66 to provide an exemplar output differential 68 (as shown in the last column of FIG. 3). It should be appreciated that the data selected for input will depend on specific print production enterprise resources and requirements.

An experimental neural network 12 was trained based on the absolute error between the output and the prediction to be less than 3.5 h. A neural network 12 that works on back-propagation algorithm was selected for training. The results of training with 250 jobs is shown in Table 1. Once the neural network 12 was trained, it was used to predict the turnaround times of 250 jobs, and the predicted results were compared with actual turnaround times. It was found that the network 12 was able to predict the turnaround time of 243 jobs out of 250 jobs to within 3.5 h, which is about 97% accurate.

TABLE 1

| | Training Set | Test Set |
|---|---|---|
| # of Rows: | 250 | 51 |
| Average AE: | 0.52922937 | 1.04184249 |
| Average MSE: | 0.95381631 | 3.6291642 |
| Tolerance Type: | Absolute | Absolute |
| Tolerance: | 2 | 3.5 |
| # of Good Forecasts: | 238 (95%) | 48 (94%) |
| # of Bad Forecasts: | 12 (5%) | 3 (6%) |

Rsquared: 0.5262
Correlation: 0.7367

The methodology discussed above has been implemented in an Excel environment seamlessly within an Excel®-based print shop scheduling tool. However, other implementations are also feasible.

Once it has been trained 22, the neural network 12 is used to plan 70 print jobs received by the print production enterprise. The network 12 captures the variability in shop loading and job profiles and uses them to forecast turnaround time estimates. These are extremely hard to model from first principle and therefore this empirical statistical approach is attractive. The network may be continually trained, after production is implemented 72, by monitoring 74 the workflow, measuring 76 the workflow variables and utilizing 78 the new values of the measured variables in the neural network. This approach allows the neural network 12 to account for “learning curve” improvements in efficiency and to capture changing operating conditions. This approach can also be used on specific print production enterprises if they have a web-based job submission engine to predict turnaround time with minimal human intervention and can be integrated as a module. If the neural network 12 is maintained at a location remote from the print production enterprise, the workflow variables measured during production are transmitted to the neural network 12, via the Internet, over a LAN, by radio, or by other means, and the neural network analysis results are in turn transmitted back to the print production enterprise.

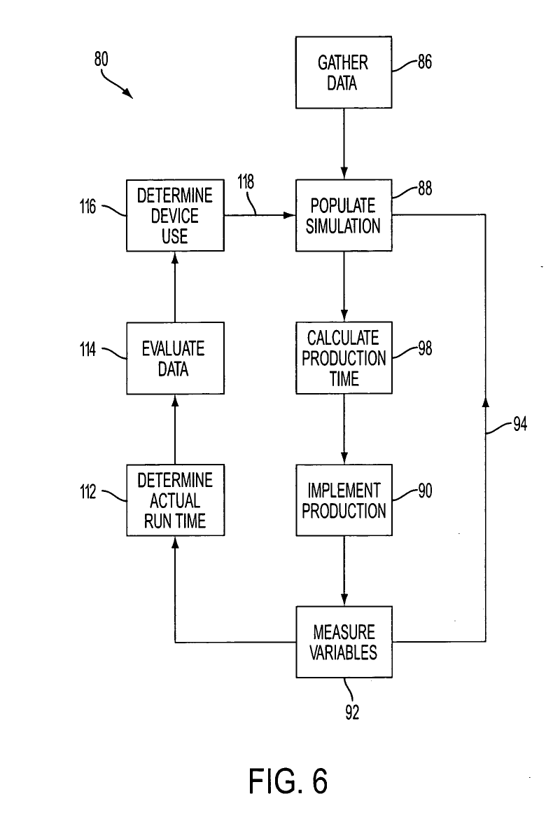

With reference to FIG. 6, a second embodiment of a method for planning print production 80 in accordance with the present disclosure utilizes statistical modeling techniques, in particular Monte Carlo simulations, to predict the likelihood that a job will be completed within a given window of time. A statistical model production planning system 80 allows a print production enterprise to schedule completion of a job based on a variety of information. Some of this information includes what discrete operations are needed to complete the job. In a bindery, for example, these discrete operations could be cutting, scoring, folding, etc. In a prepress environment, these discrete operations could include preflight, imposition, stripping, etc.

Initially, the production planning system 80 is configured with a statistical description of times to be used in the Monte Carlo simulation 82 for each operation that may be performed within the print shop. Each of the operations that is performed to complete a job serves as a data point in the Monte Carlo simulation 82. The amount of time that it takes to perform a specific task (associated with a discrete operation) is typically based on a small number of parameters (e.g. it takes “n” minutes to make 5 cuts on 10,000 prints). The statistical description represents the probabilities of performing the operation in a given time duration.

The statistical model subject production planning system 80 divides each of the discreet operations into quantity ranges (e.g. printing might be segregated into 500 page ranges, cutting may be segregated by the number of cuts, etc.). The system characterizes the ranges for each operation discreetly for greater accuracy. For example, the time required to print each copy of a 100 copy job may be disproportionately large because setup consumes a larger portion of the total time. Segregating the print operation by print ranges provides predictions that are more accurate.

Successful completion of a given print job within a certain time frame is dependent on successful completion of the print jobs that are queued up before said print job. In addition, the ability to complete a job within a specified window of time is also limited by what other work is being done in the shop. To this end, each job retains a Monte Carlo simulation 82 that is updated to reflect the work yet to be done as the job moves through the shop. In addition, the statistical model subject production planning system 80 determines how much work each required operation has scheduled, evaluates the data from the Monte Carlo simulations 82 for those jobs and determines how long the required devices (discrete operations) are likely to be in active use. This information is then added to the required times for each operations so that the times are aggregated into the overall assessment (the “forecast”) of whether a job can be completed within the specified window of time.

Job data, including job metadata, production times, and scheduled workload data, is gathered 86, and the variable of a Monte Carlo simulation 82 are populated 88 with this data. This information is initially entered into the production planning system 80 as a “standard”. After the production planning system 80 has been implemented 90 to plan the print production enterprise work load, actual job data is measured 92 and this actual operating data is fed back 94 to the Monte Carlo simulation 82. If a comparison reveals that the actual operating data differs from the “standards” in the simulation 82, the affected variables are adjusted to reflect these actual values. In addition to measurements of actual shop performance variables, the job metadata 96 (e.g. quantity, operations, etc.) may be used to fine-tune the simulation estimates. The distribution curve for each operation may also be tailored to fit the actual data that comes from the shop floor. Since the value range and distribution profile are tailored to specific quantity ranges within each operation, the system should over time provide improved accuracy.

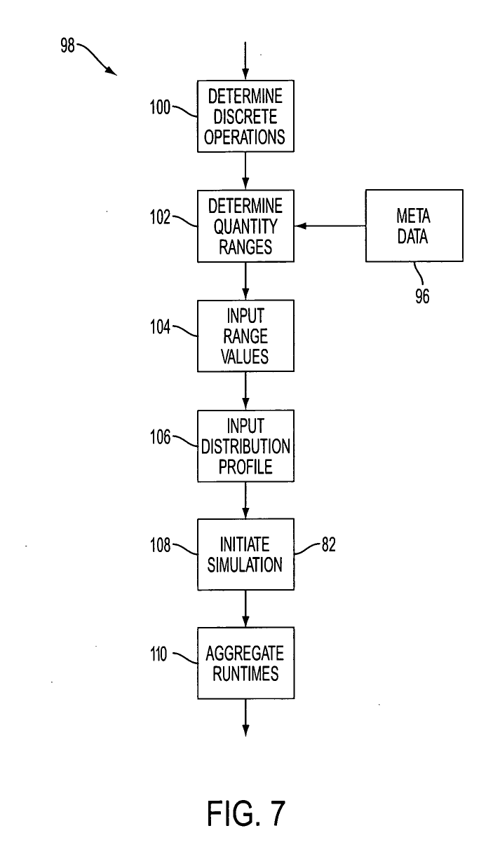

The print job description determines what specific discrete operations will be performed in completing the print job. With reference to FIG. 7, to calculate 98 the production time for each print job, the production planning system 80 determines 100 the specific operations within the Monte Carlo simulation 82 that need to be simulated to simulate the complete print job. The statistical model subject production planning system 80 determines 102 the proper quantity range for each of the defined operations (based on job meta data). For example a print job may need to be imposed (1 operation), printed (10,000 sheets—1 operation), folded (1 operation), stitched (one operation) and cut (3 operations). The statistical model subject production planning system 80 then inputs 104 the current set of range values, inputs 106 the statistical distribution profile for the specific quantity range for each operation (based on actual shop data), and then initiates 108 the Monte Carlo simulation 82. At this point, the statistical model subject production planning system knows how long each operation is likely to take. The estimated run times for all of the discrete operation operations are aggregated 110 into an estimated run time for the print job.

Successful completion of a given print job within a certain time frame is dependent on successful completion of the print jobs that are queued up before said print job. So, the statistical model subject production planning system 80 determines 112 how much work each required operation has scheduled, evaluates 114 data from the Monte Carlo simulations for those jobs and determines 116 how long the required devices (discrete operations) are likely to be in active use. This information is then added 118 to the required times for each operation so that the times are aggregated into the overall assessment (the “forecast”) of whether a job can be completed within the specified window of time.

It should be appreciated that the subject statistical model subject production planning system 80 utilizes statistical modeling techniques, in particular Monte Carlo simulations, to predict the likelihood that a print job will be completed within a given window of time. Once production planning has been completed for a given print job, the statistical model subject production planning system 80 initiates 108 a Monte Carlo simulation 82 taking into account all operations required to complete the job. The results of these simulations are aggregated 110 into a probability that will indicate the likelihood that the print job will be completed by the time required. The statistical model subject production planning system adjusts both the range of values and the statistical distribution of those values in the Monte Carlo simulation based on actual data from the shop floor.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method of planning print production in a print production enterprise having a plurality of print equipment components comprises:
creating a neural network having a plurality of neurons, each of the neurons being connected to at least one other neuron by a logic connection;
training the neural network; and
planing a print job utilizing the trained neural network.

2. The method of claim 1 further comprising:
implementing production of the print job planned by the trained neural network;
measuring at least one workflow variable associated with the print job; and
utilizing the measured variables to retrain the neural network.

3. The method of claim 1 wherein creating the neural network comprises:
inventorying the print equipment components; and
modeling a workflow of the print production enterprise.

4. The method of claim 3 wherein creating the neural network also comprises mapping the print equipment components.

5. The method of claim 3 further comprising updating the neural network when:
a new equipment component is added to the print production enterprise; or
a one of the print equipment components is permanently removed from the print production enterprise.

6. The method of claim 5 wherein the neural network is also updated when:
a one of the print equipment components is unavailable due to maintenance or repair; or
a one of the print equipment components is unavailable due to a prior commitment to another print job.

7. The method of claim 2 wherein the neural network is at a location remote from the print production enterprise and the method further comprises transmitting the measured variables from the print production enterprise to the remote neural network.

8. The method of claim 7 further comprising transmitting a planned print job from the remote neural network to the print production enterprise.

9. The method of claim 1 wherein training the neural network comprises:
measuring a plurality of workflow variables associated with the print equipment components; and
assigning a weighting factor to each logic connection.

10. The method of claim 1 wherein training the neural network comprises:
examining workflow variable information from an existing print production enterprise;
assigning a weighting factor to each logic connection.

11. A method of planning print production in a print production enterprise having at least one print shop equipment component performing at least one discrete printing operation comprises:
gathering print job data;
populating a plurality of variables of a Monte Carlo simulation algorithm with the print job data;
calculating the print job production run time utilizing the Monte Carlo simulation algorithm;
implementing the print job production run;
measuring a plurality of workflow variables associated with the print job production run; and
conforming the variables of the Monte Carlo simulation algorithm to the measured workflow variables.

12. The method of claim 11 wherein the print job data includes data selected from job metadata, production run times, and scheduled workload data.

13. The method of claim 11 wherein calculating the print job production run time comprises:
defining the specific operations that need to be simulated to simulate the print job;
determining a proper: quantity range for each of the defined operations;
inputting a current set of range values into the Monte Carlo simulation;
inputting a statistical distribution profile for the specific quantity range for each operation into the Monte Carlo simulation; and
initiating the Monte Carlo simulation.

14. The method of claim 13 wherein calculating the print job production run time also comprises aggregating the estimated run times for all of the discrete operation operations into an estimated run time for the print job.

15. The method of claim 13 further comprising:
identifying other print jobs in production in the print production enterprise;
determining a quantity of work each defined operation has scheduled for the other print jobs;
evaluating data from the Monte Carlo simulations for the other print jobs;
determining a time of active operation for each print equipment component required to perform the identified operations of the other print jobs; and
aggregating the required times for each operation for each print equipment component for the other print jobs.

16. The method of claim 13 wherein determining a proper quantity range for each of the defined operations includes dividing at least one of the discreet operations into a plurality of quantity ranges.

17. The method of claim 16 wherein the proper quantity range for each of the defined operations is determined based on job meta data.

18. The method of claim 13 wherein the statistical distribution profile for the specific quantity range is determined based on actual shop data.

19. A method of planning print shop production in a print production enterprise having a plurality of print equipment components performing a plurality of discrete printing operations comprises:
gathering print job data;
populating a plurality of variables of a simulation algorithm with the print job data;
planning the print job production run utilizing the simulation algorithm;
implementing the print job production run;
measuring a plurality of workflow variables associated with the print job production run; and
conforming the variables of the simulation algorithm to the measured workflow variables.

20. The method of claim 19 wherein the simulation algorithm is a Monte Carlo simulation calculating a print job production run time.

21. The method of claim 19 wherein the simulation algorithm is a neural network having a plurality of neurons, each of the neurons being associated with a print equipment component and being connected to at least one other neuron by a logic connection, each logic connection being associated with a print operation.

22. A method of planning print production in a print production enterprise having at least one print shop equipment component performing at least one discrete printing operation comprises:
gathering print job data;
populating at least one variable of a Monte Carlo simulation algorithm with the print job data;
calculating the print job production run time utilizing the Monte Carlo simulation algorithm;
implementing the print job production run;
measuring at least one workflow variable associated with the print job production run; and
conforming the at least one variable of the Monte Carlo simulation algorithm to the at least one measured workflow variable.
